(19) United States
(12) Patent Application Publication
(10) Pub. No.: US 2007/0037715 A1
(43) Pub. Date: Feb. 15, 2007

(54) LUBRICATING OIL COMPOSITION AND OIL-IMPREGNATED BEARING USING THE SAME

(75) Inventor: Tahei OKADA, Ichihara-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 11/463,433

(22) Filed: Aug. 9, 2006

(30) Foreign Application Priority Data
Aug. 12, 2005 (JP) 2005-234487

(51) Int. Cl. C10M 145/14; F16C 33/02

(52) U.S. Cl. 508/469; 384/279

(57) ABSTRACT

A lubricating oil composition contains: an ester as a base oil formed from a dibasic acid having a carbon number of 9 to 12 and a primary alcohol having a side chain and a carbon number of 8 to 13; and an alkyl(metha)acrylate polymer having an SP (solubility parameter) value of 9.2 or higher and a mass average molecular weight of 1×10⁵ to 1×10⁶, the alkyl(metha)acrylate polymer being contained in an amount of 0.5 to 10 mass % of a total amount of the composition. A viscosity of the composition at 100° C. is 9.3 to 11.5 mm²/s.

### BACKGROUND OF THE INVENTION

1. Field of the Invention

The present invention is related to a lubricating oil composition and an oil-impregnated bearing using the lubricating oil composition.

2. Description of Related Art

Recently, there has been increasingly used a so-called oil-impregnated bearing as a bearing for automobile electric equipment, household electric appliances and OA equipment, the oil-impregnated bearing being molded by sintering metallic powder. The oil-impregnated bearing is excellent in durability and rigidity, and can be manufactured at lower cost than conventional ball bearings.

In order to manufacture such oil-impregnated bearing, after processes such as mixing of the metallic powder, molding, sintering, sizing, etc., the bearing is vacuum-impregnated with a lubricating oil according to an application and a performance by an impregnating apparatus. As the lubricating oil to be impregnated, there have been conventionally known a mineral oil system, a polyalphaolefin (PAO), an alkylated diphenyl ether, a fatty acid ester, a fluorinated oil, a silicone oil and the like. Using these oils as a base oil, various additives such as an antioxidant, a rust inhibitor and an antiwear agent are added to the base oil for use.

Required performances of the lubricating oil for the oil-impregnated bearing may be a proper viscosity characteristic, a lubricating property, a long-term stability, a volatility resistance, a material compatibility (with metals, resins, etc.) and the like.

Meanwhile, recent technology has been aiming at higher quality, higher speed and downsizing of oil-impregnated bearings, and service conditions thereof have been becoming stricter. For example, an electric motor is used for a recent automobile, and an oil-impregnated bearing has been increasingly employed as a bearing for the motor. In such case, the electric motor for the automobile requires capability of driving at −40° C. in cold areas such as North Europe and North America, while requiring durability (i.e., no change in viscosity and small evaporation loss) at 120° C. since ambient temperature becomes high in an engine compartment. In other words, there has been a demand for an oil-impregnated bearing and a lubricating oil for the oil-impregnated bearing that can be used stably from a low temperature region to a high temperature region.

In order to fulfill such requirements, it is common now that different ester-based bearing oils are used for a high temperature and a low temperature. In addition, there has been made an approach in which two types of perfluoroether oils having different backbone structures are mixed to provide synergistic effect to a fluid characteristic of a lubricating oil in order to improve startability, maintenance of lubricity at a high temperature and fluidity at a low temperature (see, for instance, JP-B-3-69394).

However, once the oil-impregnated bearing is filled with the lubricating oil, it is generally used without additional oil feeding. Accordingly, in order to use different lubricating oils for a high temperature and a low temperature, the bearing itself has to be replaced, which is quite inconvenient.

Moreover, the invention disclosed in Document is not an invention intended to be applied to a sintered oil-impregnated bearing. Furthermore, the invention only improves the fluid characteristic, but does not improve required performances of the oil-impregnated bearing such as wear resistance, coefficient of friction, rust resistance and diffusibility.

### SUMMARY OF THE INVENTION

An object of the present invention is to provide a lubricating oil composition, particularly for oil-impregnated bearings, capable of maintaining excellent performances from a low temperature region to a high temperature region, as well as an oil-impregnated bearing using the lubricating oil composition.

A lubricating oil composition according to an aspect of the present invention includes: an ester as a base oil formed from a dibasic acid having a carbon number (atom) of 9 to 12 and a primary alcohol having a side chain and a carbon number of 8 to 13; and an alkyl(metha)acrylate polymer having an SP (solubility parameter) value of 9.2 or higher and a mass average molecular weight of 1×10⁵ to 1×10⁶, a content of the alkyl (metha)acrylate polymer being 0.5 to 10 mass % of a total amount of the lubricating oil composition, in which a viscosity of the composition at 100° C. is 9.3 to 11.5 mm²/s.

Herein, the alkyl(metha)acrylate polymer may be any polymer as long as it has an alkyl acrylate or an alkyl methacrylate as a monomer unit, which may include, for instance, copolymers such as an alkyl acrylate-alkyl methacrylate copolymer.

According to the aspect of the present invention, the ester formed from the dibasic acid having the carbon number of 9 to 12 and the primary alcohol having the side chain and the carbon number of 8 to 13 is used as the base oil. Accordingly, when, for instance, the ester is used as the base oil of the lubricating oil composition for an oil-impregnated bearing, it can realize a good drive property at a low temperature, while realizing small evaporation loss at a high temperature.

Since the alkyl(metha)acrylate polymer having the SP (solubility parameter) value of 9.2 or higher and the mass average molecular weight of 1×10⁵ to 1×10⁶ is contained as the viscosity index improver in an amount of 0.5 to 10 mass % of the total amount of the composition, excellent solubility in the above-described ester as the base oil can be obtained. The mass average molecular weight is preferably in the range from 2×10⁵ to 5×10⁵.

In addition, since the viscosity of the composition at 100° C. is 9.3 to 11.5 mm²/s, the viscosity change is small from a low temperature region to a high temperature region, thus realizing consistent lubricating effect.

The lubricating oil composition according to the aspect of the present invention preferably includes at least one member of additives selected from the group consisting of an antioxidant, a friction modifier, a detergent dispersant, a metal deactivator, an antifoaming agent, a thickener and an antistatic agent.

According to the aspect of the present invention, since the lubricating oil composition contains at least one member of additives selected from the above-described group of additives, the lubricating oil composition, when used as the lubricating oil, can provide effects such as little aging degradation, excellent lubricating oil characteristics, etc. in accordance with each of the additives. Especially, since the lubricating oil for the oil-impregnated bearing is difficult to be replaced, it is preferable to contain such additives.

According to the aspect of the present invention, the antioxidant is preferably at least one member selected from the group consisting of an amine type antioxidant, a phenolic antioxidant and a sulfur-containing antioxidant.

According to the aspect of the present invention, when the antioxidant is at least one member selected from the group consisting of the amine type antioxidant, the phenolic antioxidant and the sulfur-containing antioxidant, antioxidant effect of the lubricating oil composition can be effectively enhanced.

According to the aspect of the present invention, the friction modifier is preferably at least one member selected from the group consisting of phosphates, amine salts thereof and a sulfur-containing extreme pressure agent.

According to the aspect of the present invention, when the friction modifier is at least one member selected from the group consisting of the phosphates, the amine salts thereof and the sulfur-containing extreme pressure agent, the lubricating property of the lubricating oil composition can be effectively controlled.

An oil-impregnated bearing according to another aspect of the present invention uses the above-described lubricating oil composition of the present invention.

According to the aspect of the present invention, since the oil-impregnated bearing is impregnated with the above-described lubricating oil composition, the oil-impregnated bearing can maintain excellent lubricating performance from the low temperature region to the high temperature region. In addition, the oil-impregnated bearing provides small evaporation loss at a high temperature as well as excellent durability.

### DETAILED DESCRIPTION OF PREFERRED EMBODIMENT(S)

A preferred embodiment for implementing the present invention will be described below.

A base oil of a lubricating oil composition of the present invention employs an ester formed from a dibasic acid having e carbon number of 9 to 12 and a primary alcohol having the side chain and e carbon number of 8 to 13.

Examples of the dibasic acid having the carbon number of 9 to 12 may include an azelaic acid, a sebacic acid and a dodecanedioic acid.

When the carbon number of the dibasic acid is 8 or less, a high viscosity index cannot be obtained, which causes increased change in viscosity due to temperature change. On the other hand, when the carbon number is 13 or more, the pour point becomes high and low-temperature characteristics are degraded.

As the primary alcohol having the side chain and the carbon number of 8 to 13, 2-ethylhexanol, 3,3,5-trimethylhexanol, dimethyl octanol, isotridecanol and the like can be used.

When the carbon number of the primary alcohol is 7 or less, a high viscosity index cannot be obtained, which causes increased change in viscosity due to temperature change. On the other hand, when the carbon number is 14 or more, the pour point becomes high and the low-temperature characteristics are degraded.

Herein, the carbon number of the above-described ester (i.e., a total carbon number of the dibasic acid and the primary alcohol) is 25 to 38, which is preferably 26 to 36, and more preferably 28 to 34. The total carbon number of below 25 causes evaporation loss of the resulting lubricant oil composition to increase, which degrades durability of an oil-impregnated bearing when used for the bearing. On the other hand, when the total carbon number of the above-described ester exceeds 38, the viscosity of the base oil becomes too high, which degrades a drive property of a rotary shaft relative to the oil-impregnated bearing at a low temperature. Incidentally, the evaporation loss can be measured in compliance with JIS K 2540.

In the present invention, one type of esters as described above may be used alone or two or more types may be used in combination as the base oil.

In the composition of the present invention, an alkyl(metha)acrylate polymer having an SP (solubility parameter) value of 9.2 or higher and a mass average molecular weight of 1×10⁵ to 1×10⁶ is used as a viscosity index improver to be added to the base oil, the mass average molecular weight preferably being 2×10⁵ to 5×10⁵.

When the SP value is below 9.2, viscosity-index improving effect is degraded. The SP value is preferably 9.3 or higher. Note that, when the base oil is a mineral oil, a macromolecule (polymer) having an SP value of 9.2 or higher is not soluble therein. However, the base oil used in the present invention is a specific ester as described above and is excellent in dissolving the alkyl(metha)acrylate polymer having a high SP value.

When the mass average molecular weight of the alkyl(metha)acrylate polymer is below 1×10⁵, the viscosity-index improving effect is small. On the other hand, when the mass average molecular weight exceeds 1×10⁶, the resulting composition has high viscosity, which makes it difficult to handle.

Herein, the alkyl(metha)acrylate polymer may be any polymer as long as it has an alkyl acrylate or an alkyl methacrylate as a monomer unit, which may include, for instance, copolymers such as an alkyl acrylate-alkyl methacrylate copolymer.

One type of viscosity index improvers as described above may be used alone or two or more types may be used in combination. A content of the viscosity index improver is 0.5 to 10 mass % of the total amount of the composition, preferably 1 to 5 mass %. When the content is less than 0.5 mass %, the viscosity-index improving effect is small. When the content exceeds 10 mass %, the viscosity-index improving effect is not enhanced so much, and rather the viscosity of the composition itself becomes too high, which degrades a lubricating property.

The lubricating oil composition of the present invention has the viscosity at 100° C. of 9.3 to 11.5 mm²/S. When the viscosity at 100° C. is below 9.3 mm²/s, a lubricant film cannot be formed properly at a high temperature, causing insufficient lubricating property. On the other hand, when the viscosity at 100° C. exceeds 11.5 mm²/s, the viscosity at a low temperature becomes too high, again causing insufficient lubricating property.

The SP value in the present invention is a value obtained by Fedors method [Poym. Eng. Sci. 14(2)152 (1974)]. The viscosity index can be measured in compliance with JIS K 2283.

The lubricating oil composition of the present invention contains: the ester, as the base oil, formed from the dibasic acid having the carbon number of 9 to 12 and the primary alcohol having the side chain and the carbon number of 8 to 13; and the alkyl (metha)acrylate polymer having the SP (solubility parameter) value of 9.2 or higher and the mass average molecular weight of 1×10⁵ to 1×10⁶, the alkyl(metha)acrylate polymer being contained in an amount of 0.5 to 10 mass % of the total amount of the composition. Since the viscosity of the composition at 100° C. is 9.3 to 11.5 mm²/s, viscosity change is small from a low temperature region to a high temperature region, while realizing small evaporation loss.

Accordingly, the lubricating oil composition can be used for oil-impregnated bearings made of various sintered metals by impregnating the bearings with the lubricating oil composition to form oil-impregnated bearing units.

Such oil-impregnated bearing units can be used for various types of bearings, which may be applied to, for instance, a motor bearing for a motor of automobile electric equipment and a capstan bearing.

In the present invention, various additives may be added to the lubricating oil composition as needed, examples of the additives including an antioxidant, a friction modifier, a detergent dispersant, a metal deactivator, an antifoaming agent, a thickener, an antistatic agent and the like.

The antioxidant may be exemplified by an amine type antioxidant, a phenolic antioxidant and a sulfur-containing antioxidant.

Examples of the amine type antioxidant may include: monoalkyldiphenylamine systems such as monooctyldiphenylamine and monononyldiphenylamine; dialkyl diphenylamine systems such as 4,4′-dibutyldiphenylamine, 4,4′-dipentyldiphenylamine, 4,4′-dihexyldiphenylamine, 4,4′-diheptyldiphenylamine, 4,4′-dioctyldiphenylamine and 4,4′-dinonyldiphenylamine; polyalkyldiphenylamine systems such as tetrabutyldiphenylamine, tetrahexyldiphenylamine, tetraoctyldiphenylamine and tetranonyldiphenylamine; and naphthylamine systems such as alpha-naphthylamine, phenyl-alpha-naphthylamine, butylphenyl-alpha-naphthylamine, pentylphenyl-alpha-naphthylamine, hexylphenyl-alpha-naphthylamine, heptylphenyl-alpha-naphthylamine, octylphenyl-alpha-naphthylamine and nonylphenyl-alpha-naphthylamine. Among these, the dialkyl diphenylamine systems are particularly preferable. One type of amine type antioxidants as described above may be used alone or two or more types may be used in combination.

Examples of the phenolic antioxidant may include: monophenol systems such as 2,6-di-tert-butyl-4-methylphenol and 2,6-di-tert-butyl-4-ethylphenol; diphenol systems such as 4,4′-methylenebis(2,6-di-tert-butylphenol) and 2,2′-methylenebis(4-ethyl-6-tert-butylphenol); and high-molecular form phenol systems such as tetrakis[methylene-3-(3,5-di-tert-butyl-4-hydroxyphenyl)propionate]methane. One type of phenolic antioxidants as described above may be used alone or two or more types may be used in combination.

Examples of the sulfur-containing antioxidant may include: phenothiazine, pentaerythritol-tetrakis(3-lauryl-thiopropionate), bis(3,5-tert-butyl-4-hydroxybenzyl)sulfide, thiodiethylenebis(3-(3,5-di-tert-butyl-4-hydroxypheny))propionate and 2,6-di-tert-butyl-4-(4,6-bis(octylthio)-1,3,5-triazine-2-methylamino)phenol. One type of sulfur-containing antioxidants as described above may be used alone or two or more types may be used in combination.

In addition, two or more systems of the above-described antioxidants may be used in combination.

The content of such antioxidant is preferably in the range from 0.01 to 10 mass % of the total amount of the composition, more preferably from 0.03 to 5 mass %.

The friction modifier may be those generally used as an oil-based agent or an extreme pressure agent, which may be particularly exemplified by a phosphate, an amine salt of a phosphate, and a sulfur-containing extreme pressure agent.

The phosphate may include a phosphate, an acid phosphate, a phosphite and an acid phosphate which are represented by general formulae (I) to (V) below.

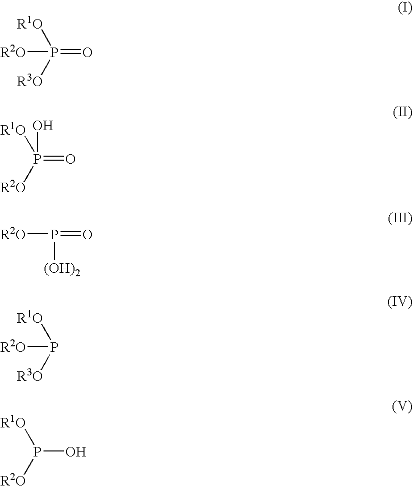

In the general formulae (I) to (V) above, R1 to R3 each represent an alkyl group or an alkenyl group having a carbon number of 4 to 30, an aryl group or an alkyl aryl group having a carbon number of 6 to 30 or an aralkyl group having a carbon number of 7 to 30, where R1 to R3 may be the same or different from each other.

Examples of the phosphate may include an aryl phosphate, an alkyl phosphate, an alkyl aryl phosphate, an aralkyl phosphate and an alkenyl phosphate, example of which may include a triphenyl phosphate, a tricresyl phosphate, a benzyl diphenyl phosphate, an ethyl diphenyl phosphate, a tributyl phosphate, an ethyl dibutyl phosphate, a cresyl diphenyl phosphate, a dicresyl phenyl phosphate, an ethylphenyl diphenyl phosphate, a diethylphenyl phenyl phosphate, a propylphenyl diphenyl phosphate, a dipropylphenyl phenyl phosphate, a triethylphenyl phosphate, a tripropylphenyl phosphate, a butylphenyl diphenyl phosphate, a dibutylphenyl phenyl phosphate, a tributylphenyl phosphate, a trihexyl phosphate, a tri(2-ethylhexyl)phosphate, a tridecyl phosphate, a trilauryl phosphate, a trimyristyl phosphate, a tripalmityl phosphate, a tristearyl phosphate and a trioleyl phosphate.

Examples of the acid phosphate may include a 2-ethylhexyl acid phosphate, an ethyl acid phosphate, a butyl acid phosphate, an oleyl acid phosphate, a tetracosyl acid phosphate, an isodecyl acid phosphate, a lauryl acid phosphate, a tridecyl acid phosphate, a stearyl acid phosphate and an isostearyl acid phosphate.

Examples of the phosphite may include a triethyl phosphite, a tributyl phosphite, a triphenyl phosphite, a tricresyl phosphite, a tri(nonylphenyl)phosphite, a tri(2-ethylhexyl)phosphite, a tridecyl phosphite, a trilauryl phosphite, a triisooctyl phosphite, a diphenylisodecyl phosphite, a tristearyl phosphite and a trioleyl phosphite.

Examples of the acid phosphite may include a dibutyl hydrogen phosphate, a dilauryl hydrogen phosphate, a dioleyl hydrogen phosphate, a distearyl hydrogen phosphate and a diphenyl hydrogen phosphate. Among the phosphates above, the tricresyl phosphate and the triphenyl phosphate are particularly preferable.

Amines that form amine salts with the phosphates may be a monosubstituted amine, a disubstituted amine or a trisubstituted amine, which is represented by a general formula (VI);
R4nNH3-n (VI)
(In the formula, R4 represents an alkyl group or an alkenyl group having a carbon number of 3 to 30, an aryl group or an aralkyl group having a carbon number of 6 to 30 or a hydroxyalkyl group having a carbon number of 2 to 30; and n represents 1, 2 or 3. When there are a plurality of R4, the plurality of R4 may be the same or different from each other.)

The alkyl group or the alkenyl group having the carbon number of 3 to 30 represented by R4 in the general formula (VI) above may be straight-chained, branched or cyclic.

Examples of the monosubstituted amine may include a butylamine, a pentylamine, a hexylamine, a cyclohexylamine, an octylamine, a laurylamine, a stearylamine, an oleylamine and a benzylamine. Examples of the disubstituted amine may include a dibutylamine, a dipentylamine, a dihexylamine, a dicyclohexylamine, a dioctylamine, a dilaurylamine, a distearylamine, a dioleylamine, a dibenzylamine, a stearyl monoethanolamine, a decyl monoethanolamine, a hexyl monopropanolamine, a benzyl monoethanolamine, a phenyl monoethanolamine and a tolyl monopropanolamine. Examples of the trisubstituted amine may include a tributylamine, a tripentylamine, a trihexylamine, a tricyclohexylamine, a trioctylamine, a trilaurylamine, a tristearylamine, a trioleylamine, a tribenzylamine, a dioleyl monoethanolamine, a dilauryl monopropanolamine, a dioctyl monoethanolamine, a dihexyl monopropanolamine, a dibutyl monopropanolamine, an oleyl diethanolamine, a stearyl dipropanolamine, a lauryl diethanolamine, an octyl dipropanolamine, a butyl diethanolamine, a benzyl diethanolamine, a phenyl diethanolamine, a tolyl dipropanolamine, a xylyl diethanolamine, a, triethanolamine and a tripropanolamine.

The sulfur-containing extreme pressure agent may be any agent as long as the agent has a sulfur atom in a molecule, solves or uniformly disperses in the base oil of the lubricating oil and is capable of realizing an extreme-pressure property and an excellent friction characteristic. Examples of such sulfur-containing extreme pressure agent may include sulfurized fat and oil, a sulfurized fatty acid, an ester sulfide, an olefin sulfide, a dihydrocarbyl polysulfide, a thiadiazole compound, a thiophosphate ester (thiophosphite, thiophosphate), an alkylthiocarbamoyl compound, a thiocarbamate compound, a thioterpene compound and a dialkyl thiodipropionate compound. Herein, the sulfurized fat and oil may be obtained by reacting fat and oil (e.g., lard oil, whale oil, vegetable oil and fish oil) with a sulfur or a sulfur-containing compound. A content of the sulfur is not particularly limited, but 5 to 30 mass % is generally preferable. Concrete examples of the sulfurized fat and oil may include a surfurized lard, a sulfurized rape seed oil, a sulfurized castor oil, a sulfurized soybean oil and a sulfurized rice bran oil. The sulfurized fatty acid may be exemplified by a sulfurized oleic acid, while the ester sulfide may be exemplified by a sulfurized methyl oleate and a sulfurized rice bran fatty acid octyl.

The olefin sulfide may be exemplified by a compound represented by a general formula (VII) below;
R5—Sa—R6 (VII)
(In the formula, R5 represents an alkenyl group having a carbon number of 2 to 15; R6 represents an alkyl group or an alkenyl group having a carbon number of 2 to 15; and a represents an integer of 1 to 8.)

The compound can be obtained by making an olefin having a carbon number of 2 to 15 or a dimer to a tetramer thereof react with a sulfurizing agent such as a sulfur, a sulfur chloride, etc. The olefin may preferably be a propylene, an isobutene, a diisobutene and the like.

The dihydrocarbyl polysulfide may be exemplified by a compound represented by a general formula (VIII) below;
R7—Sb—R8 (VIII)
(In the formula, R7 and R8 each represent an alkyl group or a cyclic alkyl group having a carbon number of 1 to 20, an aryl group having a carbon number of 6 to 20, an alkyl aryl group having a carbon number of 7 to 20 or an aralkyl group having a carbon number of 7 to 20, which may be the same or different from each other.)

Herein, when R7 and R8 are the alkyl group groups, the dihydrocarbyl polysulfide is referred to as an alkyl sulfide.

Examples of R7 and R8 in the general formula (VIII) may include a methyl group, an ethyl group, an n-propyl group, an isopropyl group, an n-butyl group, an isobutyl group, a sec-butyl group, a tert-butyl group, various pentyl groups, various hexyl groups, various heptyl group, various octyl group, various nonyl group, various decyl group, various dodecyl group, a cyclohexyl group, a cyclooctyl group, a phenyl group, a naphthyl group, a tolyl group, a xylyl group, a benzyl group and a phenethyl group.

Examples of the dihydrocarbyl polysulfide may include a dibenzyl polysulfide, various dinonyl polysulfides, various didodecyl polysulfides, various dibutyl polysulfides, various dioctyl polysulfides, a diphenyl polysulfide and a dicyclohexyl polysulfide.

As the thiadiazole compound, 1,3,4-thiadiazole, a 1,2,4-thiadiazole compound, 1,4,5-thiadiazole and the like represented by a general formula (IX) below may be preferably used; 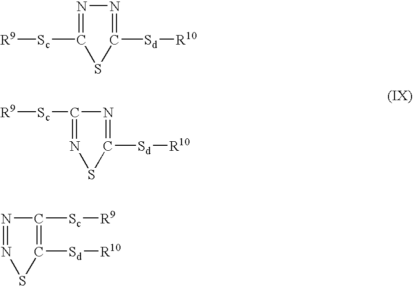
(In the formula, R9 and R10 each represent a hydrogen atom or a hydrocarbon group having a carbon number of 1 to 20; and c and d each represent an integer of 0 to 8.)

Examples of the thiadiazole compound may include 2,5-bis(n-hexyldithio)-1,3,4-thiadiazole, 2,5-bis(n-octyldithio)-1,3,4-thiadiazole, 2,5-bis(n-nonyldithio)-1,3,4-thiadiazole, 2,5-bis-(1,1,3,3-tetramethylbutyldithio)-1,3,4-thiadiazole, 3,5-bis(n-hexyldithio)-1,2,4-thiadiazole, 3,5-bis(n-octyldithio)-1,2,4-thiadiazole, 3,5-bis(n-nonyldithio)-1,2,4-thiadiazole, 3,5-bis-(1,1,3,3-tetramethylbutyldithio)-1,2,4-thiadiazole, 4,5-bis(n-hexyldithio)-1,2,3-thiadiazole, 4,5-bis(n-octyldithio)-1,2,3-thiadiazole, 4,5-bis(n-nonyldithio)-1,2,3-thiadiazole and 4,5-bis-(1,1,3,3-tetramethylbutyldithio)-1,2,3-thiadiazole.

Examples of the thiophosphate ester may include an alkyl trithiophosphate, an aryl or alkylaryl thiophosphate, a zinc dilauryldithiophosphate, a lauryl trithiophosphite, a triphenyl thiophosphate and the like, and the lauryl trithiophosphite and the triphenyl thiophosphate are particularly preferable.

The alkylthiocarbamoyl compound may be exemplified by a compound represented by a general formula (X) below; 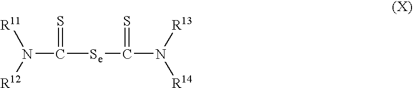
(In the formula, R11 to R14 each represent an alkyl group having a carbon number of 1 to 20; and e represents an integer of 1 to 8.)

Examples of the alkylthiocarbamoyl compound may include a bis(dimethylthiocarbamoyl)monosulfide, a bis(dibutylthiocarbamoyl)monosulfide, a bis(dimethylthiocarbamoyl)disulfide, a bis(dibutylthiocarbamoyl)disulfide, a bis(diamylthiocarbamoyl)disulfide and a bis(dioctylthiocarbamoyl)disulfide.

The thiocarbamate compound may be exemplified by, for instance, a zinc dialkyldithiocarbamate. The thioterpene compound may be exemplified by, for instance, a reaction product of a phosphorus pentasulfide and a pinene. The dialkyl thiodipropionate compound may be exemplified by, for instance, a dilauryl thiodipropionate, a distearyl thiodipropionate and the like. Among these, the thiadiazole compound and a benzyl sulfide are particularly preferable in terms of the extreme-pressure property, the friction characteristic and thermo-oxidative stability.

The content of the above-described friction modifier is preferably in the range from 0.01 to 10 mass % of the total amount of the composition, more preferably from 0.05 to 5 mass %. When the content is below 0.01 mass %, improvement of the friction characteristic due to synergistic effect with other components might not be sufficient. On the other hand, when the content exceeds 10 mass %, the improvement of the friction characteristic matching the content cannot be obtained sufficiently.

Examples of the detergent dispersant may include a metal sulfonate, a metal phenate, a metal salicylate, a metal phosphonate and a succinimide. The content of such detergent dispersant is preferably in the range from 0.01 to 10 mass % of the total amount of the composition, more preferably from 0.1 to 5 mass %.

As the metal deactivator, for instance, compounds of a benzotriazole system, a thiadiazole system and a gallic acid ester system may be used. The content of such metal deactivator is preferably in the range from 0.01 to 0.4 mass % of the total amount of the composition, more preferably from 0.01 to 0.2 mass %.

As the antifoaming agent, a liquid silicone is suitable, and a methylsilicone, a fluorosilicone and a polyacrylate may be used. The content of such antifoaming agent is preferably in the range from 0.0005 to 0.01 mass % of the total amount of the composition.

As the thickener, a metallic soap is preferable, examples of which may include 12-hydroxystearic acid Li metal salt, 12-hydroxystearic acid Ca metal salt, 12-hydroxystearic acid Na metal salt or that represented by a general formula (XI) below.
(R—COO)fM (XI)
(M represents an element such as Na, Mg, Al, K, Ca, Li, Ti, Mn, Fe, Co, Ni, Cu, Zn, etc; R represents an alkyl group, an alkyl aryl group, an alkenyl group or an aralkyl group having a carbon number of 4 to 30; and f represents an integer of 1 to 3.) In the formula (XI), M is preferably Mg, Al or Zn. The content of such thickener is preferably in the range from 0.01 to 10 mass % of the total amount of the composition, more preferably from 0.1 to 5 mass %.

Examples of the antistatic agent may include an anionic surfactant, a cationic surfactant, a nonionic surfactant and an amphoteric surfactant.

The anionic surfactant may be exemplified an alkylbenzene sulfonate, an alpha olefin sulfonate and the like. The cationic surfactant may be exemplified by quaternary ammonium salts such as an alkyltrimethylammonium salt, a dialkyl dimethyl ammonium salt, an alkyldimethylbenzylammonium salt and the like. The nonionic surfactant may be exemplified by: ethers such as a polyoxyethylene alkyl ether and a polyoxyethylene alkyl phenyl ether; esters such as a sorbitan fatty acid ester, a polyoxyethylene sorbitan fatty acid ester, a polyoxyethylene fatty acid ester; and amides such as a fatty acid alkanolamide. The amphoteric surfactant may be exemplified by an alkylbetaine as a betaine system. The content of such antistatic agent is preferably in the range from 0.01 to 10 mass % of the total amount of the composition.

Now, the present invention will be further described in detail with Examples, which by no means limit the present invention.

### EXAMPLES 1 TO 4 AND COMPARISONS 1 to 5

(1) Preparation of Lubricant Oil Composition

Lubricating oil compositions of Examples and Comparisons were prepared using esters having properties shown in Table 1 as base oils and polymers having properties shown in Table 2 as viscosity index improvers. Tables 3 and 4 show formulations of the lubricating oil compositions as well as properties (various viscosities, viscosity index and evaporation loss).

Note that Ester A and Ester B are the base oil according to the present invention, while Ester C is not the base oil according to the present invention since an alcohol part thereof is not the primary alcohol.

Each of Polymers 1 and 2 was an alkyl methacrylate-MMA copolymer, which was obtained as a 20 mass %-solution of a diisododecyl sebacate (DIDS) (manufactured by Sanyo Chemical Industries, Ltd.) and mixed with the base oil to prepare each of the lubricant base oil compositions.

Polymer 3 was a polyalkylmethacrylate, which was obtained as a 47 mass %-solution of a mineral oil (SANLUBE1502 manufactured by Sanyo Chemical Industries, Ltd.) and used for preparing the lubricating oil composition. Polymer 4 was an olefin copolymer (LUCANT HC 600 manufactured by Mitsui Chemicals, Inc), which was used alone for preparing the lubricating oil composition.

Incidentally, general-purpose additives were added in an amount of 2.31 mass % in total to each of the lubricating oil compositions of Examples and Comparisons.

Antioxidant A: octadecyl3,5-di-tert-butyl-4-hydroxyhydrocinnamate 0.5 mass %

Antioxidant B: 4,4′-bis(alpha,alpha′-dimethylbenzyl)diphenylamine 0.5 mass %

Extreme pressure agent: trixylenyl phosphate 1.0 mass %

Oil-base agent: ECA10489 (manufactured by Infineum Japan Ltd.) 0.3 mass %

Antistatic agent: 1H-benzotriazole 0.01 mass %

TABLE 1

| | | | | 40° C. | 100° C. | | Pour |
|---|---|---|---|---|---|---|---|
| | | | Molecular | viscosity | viscosity | Viscosity | point |
| | Acid part | Alcohol part | weight | (mm²/s) | (mm²/s) | index | (° C.) |
| Ester A | sebacic acid | diisododecyl | 482 | 19.3 | 4.69 | 172 | −60> |
| | | alcohol | | | | | |
| Ester B | dodecanedioic | diisooctyl | 455 | 13.7 | 3.7 | 169 | −50 |
| | acid | alcohol | | | | | |
| Ester C | C8, C10¹⁾ | NPG²⁾ | — | 19 | 4.5 | 139 | −45 |

¹⁾Mixture of carboxylic acid having a carbon number of 8, 10
²⁾Neopentylglycol

TABLE 2

| | | | Mw¹⁾ |
|---|---|---|---|
| | | SP Value | (×10⁵) |
| Polymer 1 | alkyl methacrylate-MMA | 9.8 | 482 |
| | copolymer | | |
| Polymer 2 | alkyl methacrylate-MMA | 9.39 | 455 |
| | copolymer | | |
| Polymer 3 | polyalkylmethacrylate | 9.15 | — |
| Polymer 4 | olefin copolymer | — | — |

¹⁾Mass average molecular weight

TABLE 3

| | | Example 1 | Example 2 | Example 3 | Example 4 | Reference 1 | Reference 2 |
|---|---|---|---|---|---|---|---|
| Base oil | Ester A | 93.99 | 95.87 | 52.48 | 10.96 | — | — |
| (mass %) | Ester B | — | — | 42.59 | 84 | — | — |
| | Ester C | — | — | — | — | — | — |
| | Mineral oil | — | — | — | — | — | — |
| Additive¹) | Polymer 1 | 3.70 | — | — | — | — | — |
| (mass %) | Polymer 2 | — | 1.82 | 2.62 | 2.74 | — | — |
| | Polymer 3 | — | — | — | — | — | — |
| | Polymer 4 | — | — | — | — | — | — |

| | | | | | | |
|---|---|---|---|---|---|---|
| 40° C. viscosity(mm²/s) | 38.63 | 38.52 | 10.29 | 35.18 | 34.12 | 61.66 |
| 100° C. viscosity(mm²/s) | 10.2 | 10.2 | 10.3 | 10.48 | 8.65 | 12.73 |
| BF Viscosity | 7100 | 6850 | 4880 | 3250 | 4780 | 14100 |
| (−40° C.)²⁾(mP · s) | | | | | | |
| Viscosity index | 267 | 268 | 289 | 306 | 248 | 211 |
| Evaporation loss³⁾ | 2.22 | 2.21 | 2.95 | 4.57 | 8.73 | 2.96 |
| (mass %) | | | | | | |

¹⁾The general-purpose additives (antioxidant, extreme pressure agent, etc) are added in an amount of 2.31 mass % to each of the lubricating oil compositions of Examples.
²⁾Measured in compliance with JPI-5S-26-85
³⁾Measured at 150° C. for 120 hrs, in compliance with JIS K 2540

TABLE 4

| | | Comparison 1 | Comparison 2 | Comparison 3 | Comparison 4 | Comparison 5 |
|---|---|---|---|---|---|---|
| Base oil | Ester A | 94.95 | 14.8 | 90.19 | — | — |
| (mass %) | Ester B | — | — | — | 88.69 | 81.39 |
| | Ester C | — | 79.19 | — | — | — |
| | Mineral oil | — | — | 3.97 | 4.77 | — |
| Additive¹⁾ | Polymer 1 | — | 3.7 | — | — | — |
| (mass %) | Polymer 2 | 2.74 | — | — | — | — |
| | Polymer 3 | — | — | 3.53 | 4.23 | — |
| | Polymer 4 | — | — | — | — | 16.3 |

| | | | | | |
|---|---|---|---|---|---|
| 40° C. viscosity(mm²/s) | 52.22 | 40.35 | 50.71 | 40.5 | 51.1 |
| 100° C. viscosity(mm²/s) | 14.04 | 10.18 | 10.86 | 10.03 | 10.56 |
| BF Viscosity | 8700 | 13900 | 41500 | 21300 | 13750 |
| (−40° C.)²⁾(mP · s) | | | | | |
| Viscosity index | 282 | 253 | 212 | 247 | 202 |
| Evaporation loss³⁾ | 2.16 | 2.78 | 4.72 | 9.25 | 5.19 |
| (mass %) | | | | | |

¹⁾The general-purpose additives (antioxidant, extreme pressure agent, etc) are added in an amount of 2.31 mass % to each of the lubricating oil compositions of Comparisons.
²⁾Measured in compliance with JPI-5S-26-85
³⁾Measured at 150° C. for 120 hrs, in compliance with JIS K 2540

(2) Result

All of the lubricating oil compositions of Examples 1 to 4 satisfy requirements of the present invention. Specifically, the lubricant base oil compositions each showed small viscosity change from the low temperature region to the high temperature region, as seen from the viscosities (BF viscosity at −40° C., viscosity at 40° C. and viscosity at 100° C.) and the viscosity indexes, and showed small evaporation loss at 150° C., thus realizing excellent performances as lubricating oils for oil-impregnated bearings.

In contrast, in Comparison 1, the viscosity of the composition at 100° C. was high and the lubricating property was poor. In Comparison 2, since the ester used as the base oil was not formed from the dibasic acid and the primary alcohol and the viscosity index was low, the viscosity of the composition at a low temperature (BF viscosity at −40° C.) was high. Thus when the lubricating oil composition is used as a lubricating oil for an oil-impregnated bearing, a drive power of a rotary shaft will become high at a low temperature. In Comparison 3, although Polymer 3 used as the viscosity index improver was polyalkylmethacrylate, the SP value thereof was low and the viscosity index was also low. Hence, the viscosity of the composition at a low temperature (BF viscosity at −40° C.) was high, so that Comparison 3 has a similar problem as that of Comparison 2. In addition, the evaporation loss was relatively high. Comparisons 4 used Polymer 3 as the viscosity index improver as in Comparison 3, so that Comparison 4 has a similar problem. Also, in Comparison 4, the evaporation loss was too large, so that, when the lubricating oil composition is used as a lubricating oil for an oil-impregnated bearing, durability thereof will be a problem. In Comparison 5, although the olefin copolymer generally used as a viscosity index improver was used, the viscosity-index improving effect was low, which caused a little too high viscosity at a low temperature.

Note that commercially-available lubricating oils for oil-impregnated bearings are shown in Table 3 as References 1 and 2. The lubricating oil of Reference 1 has no problem in the viscosity at a low temperature. However, the evaporation loss is large, so that there is a problem in durability. The lubricating oil in Reference 2 shows small evaporation loss and has no problem in the viscosity at a high temperature. However, the viscosity at a low temperature is too high, which causes a problem in drive power of a rotary shaft at the low temperature.

The priority application Number JP 2005-234487 upon which this patent application is based is hereby incorporated by reference.

What is claimed is:

1. A lubricating oil composition, comprising: an ester as a base oil formed from a dibasic acid having a carbon number of 9 to 12 and a primary alcohol having a side chain and a carbon number of 8 to 13; and
an alkyl(metha)acrylate polymer having an SP (solubility parameter) value of 9.2 or higher and a mass average molecular weight of 1×10⁵ to 1×10⁶, a content of the alkyl (metha)acrylate polymer being 0.5 to 10 mass % of a total amount of the lubricating oil composition, wherein
a viscosity of the composition at 100° C. is 9.3 to 11.5 mm²/s.

2. The lubricating oil composition according to claim 1, further comprising at least one member of additives selected from the group consisting of an antioxidant, a friction modifier, a detergent dispersant, a metal deactivator, an antifoaming agent, a thickener and an antistatic agent.

3. The lubricating oil composition according to claim 2, wherein the antioxidant is at least one member selected from the group consisting of an amine type antioxidant, a phenolic antioxidant and a sulfur-containing antioxidant.

4. The lubricating oil composition according to claim 2, wherein the friction modifier is at least one member selected from the group consisting of phosphates, amine salts thereof and a sulfur-containing extreme pressure agent.

5. An oil-impregnated bearing using a lubricating oil composition, wherein the lubricating oil composition comprises:
an ester as a base oil formed from a dibasic acid having a carbon number of 9 to 12 and a primary alcohol having a side chain and a carbon number of 8 to 13; and
an alkyl(metha)acrylate polymer having an SP (solubility parameter) value of 9.2 or higher and a mass average molecular weight of 1×10⁵ to 1×10⁶, a content of the alkyl (metha)acrylate polymer being 0.5 to 10 mass % of a total amount of the lubricating oil composition, and
a viscosity of the composition at 100° C. is 9.3 to 11.5 mm²/s.

6. The oil-impregnated bearing according to claim 5, wherein the lubricating oil composition comprises at least one member of additives selected from the group consisting of an antioxidant, a friction modifier, a detergent dispersant, a metal deactivator, an antifoaming agent, a thickener and an antistatic agent.

7. The oil-impregnated bearing according to claim 6, wherein the antioxidant is at least one member selected from the group consisting of an amine type antioxidant, a phenolic antioxidant and a sulfur-containing antioxidant.

8. The oil-impregnated bearing according to claim 6, wherein the friction modifier is at least one member selected from the group consisting of phosphates, amine salts thereof and a sulfur-containing extreme pressure agent.
